(19) United States
(12) Patent Application Publication
(10) Pub. No.: US 2005/0146495 A1
(43) Pub. Date: Jul. 7, 2005

(54) LCD overdrive table triangular interpolation

(75) Inventors: Andrew MacKinnon, North York (CA); Steve Selby, Scarborough (CA)

Correspondence Address: BEYER WEAVER & THOMAS LLP, P.O. BOX 70250, OAKLAND, CA, 94612-0250, US

(73) Assignee: Genesis Microchip Inc., Alviso, CA (US)

(21) Appl. No.: 10/993,108

(22) Filed: Nov. 18, 2004

Related U.S. Application Data
(60) Provisional application No. 60/561,033, filed on Apr. 9, 2004.
(60) Provisional application No. 60/527,423, filed on Dec. 5, 2003.
(60) Provisional application No. 60/527,543, filed on Dec. 5, 2003.
(60) Provisional application No. 60/527,437, filed on Dec. 5, 2003.

(51) Int. Cl. G09G 3/36

(52) U.S. Cl. 345/98

(57) ABSTRACT

A method for reducing a response time of the pixels corresponding to a period of time required for a selected pixel at a starting pixel value to reach a target pixel value. Providing an n×n LCD overdrive matrix and for a selected pixel at a particular start pixel value, selecting a particular target pixel value to be reached in one frame time, and determining a particular overdrive pixel value based upon the particular start pixel value and the particular target pixel value using triangular interpolation.

### RELATED APPLICATIONS

This patent application takes priority under 35 U.S.C. 119(e) to (i) U.S. Provisional Patent Application No. 60/561,033 (ATTORNEY DOCKET: GENSP054P) filed on Apr. 9, 2004 entitled “LCD OVERDRIVE TABLE TRIANGULAR INTERPOLATION” by Selby et al, (ii) U.S. Provisional Patent Application No.: 60/527,423(ATTORNEY DOCKET: GENSP114P) filed on Dec. 8, 2003 entitled “LCD OVERDRIVE AUTOCALIBRATION” by Selby, (iii) U.S. Provisional Patent Application No.: 60/527,543 (ATTORNEY DOCKET: GENSP115P) filed on Dec. 5, 2003 entitled “METHOD OF IMPROVING FIXED PIXEL DISPLAY RESPONSE TIME” by Selby, and (iv) U.S. Provisional Patent Application No.: 60/527,437 (ATTORNEY DOCKET: GENSP116P) filed on Dec. 5, 2003 entitled “METHOD AND APPARATUS FOR ENHANCING THE APPEARANCE OF MOTION ON AN LCD PANEL” by Selby, each of which are incorporated by reference in their entirety.

### BACKGROUND

1. Field of the Invention

The invention relates to display devices. More specifically, the invention describes a method and apparatus for enhancing the appearance of motion on an LCD panel display.

2. Overview

Each pixel of an LCD panel can be directed to assume a luminance value discretized to the standard set [0, 1, 2, . . . , 255] where a triplet of such pixels provides the R, G, and B components that make up an arbitrary color which is updated each frame time, typically 1/60^{th} of a second. The problem with LCD pixels is that they respond sluggishly to an input command in that the pixels arrive at their target values only after several frames have elapsed, and the resulting display artifacts—“ghost” images of rapidly moving objects—are disconcerting. Ghosting occurs when the response speed of the LCD is not fast enough to keep up with the frame rate. In this case, the transition from one pixel value to another cannot be attained within the desired time frame since LCDs rely on the ability of the liquid crystal to orient itself under the influence of an electric field. Therefore, since the liquid crystal must physically move in order to change intensity, the viscous nature of the liquid crystal material itself contributes to the appearance of ghosting artifacts.

In order to reduce and/or eliminate this deterioration in image quality, the LC response time is reduced, in one approach, by overdriving the pixel values such that a target pixel value (t) is reached, or almost reached, within a single frame period. In particular, by biasing the input voltage of a given pixel to an overdriven pixel value that exceeds the target pixel value for the current frame, the transition between the starting pixel value and target pixel value is accelerated in such a way that the pixel is driven to the target pixel value within the designated frame period. However, in order to efficiently calculate the overdrive pixel value, an LCD overdrive table is used that provides the appropriate overdrive pixel value that corresponds to a start, target pixel pair. Typically, an LCD overdrive table is configured as a sparse n×n (i.e., square) matrix of ROM based lookup data that assists in improving the runtime performance of LCD panels by providing only a predetermined sample of all possible LCD overdrive values such that the values not represented by the table are handled at runtime using various interpolation techniques. One major feature of the n×n matrix type lookup table is that the main table diagonal (along which the start pixel value equals the target pixel value, s=t) represents zero temporal change, or a static image. Interpolation on or in the vicinity of the main diagonal must of necessity be accurate since the human eye is more sensitive to inaccuracies in a static image than in a moving one.

Unfortunately, processing static pictures using bilinear interpolation will generate noise in the output in regions that remain relatively static. However, whenever interpolation is performed along the main diagonal of the LCD overdrive table (where the start and target pixel values are equal), many interpolation techniques result in image regions of steady color that appear to “boil” as the interpolation imposes gratuitous perturbations on the pixel values. For example, bilinear interpolation tends to produce a smooth surface since the interpolated result is a weighted sum of four sample points where the values at all four points affect the result. Therefore, instead of a straight line across the diagonal, bilinear interpolation results in an arc which means that overdrive will take place even when the start and target pixels have the same brightness.

Therefore what is required is a technique for main diagonal interpolation and near main diagonal of a square LCD overdrive table that minimizes interpolation related image artifacts for static images, or portions thereof.

### SUMMARY OF THE DISCLOSURE

What is provided is a method, apparatus, and system suitable for implementation in Liquid Crystal Display (LCDs) that reduces a pixel element response time that enables the display of high quality fast motion images thereupon.

In a liquid crystal display device having a number of pixels, a method for reducing a pixel response time required for a selected pixel at a starting pixel value to reach a target pixel value is describe. A subsampled n×n LCD overdrive table that associates each of set of n² pixel overdrive values to a set of n start pixel values and a corresponding set of n target pixel values is provided. A desired start and a target pixel value for the selected pixel is received and when both of the desired start and the target pixel values are not enumerated by the overdrive table, then an overdrive pixel value corresponding to the desired pixel values is generated using triangular interpolation. The overdrive pixel value is then applied to the selected pixel in order to reduce the pixel response time such that the target pixel value is reached within a single frame time.

In another embodiment of the invention, computer program product for reducing a response time of the pixels corresponding to a period of time required for a selected pixel at a starting pixel value to reach a target pixel value is disclosed.

In yet another embodiment, an apparatus for reducing a pixel response time required for a selected pixel at a starting pixel value to reach a target pixel value is described. The apparatus includes a receiving unit arranged to receive a desired start and a target pixel value for the selected pixel. Coupled to the receiving unit, an overdrive block generates an overdrive pixel value corresponding to the desired pixel values using triangular interpolation when both of the desired start and the target pixel values are not enumerated by the overdrive table and apply the overdrive pixel value to the selected pixel in order to reduce the pixel response time such that the target pixel value is reached within a single frame time.

### BRIEF DESCRIPTION OF THE DRAWINGS

FIG. 1 shows an exemplary overdrive table.

FIG. 2 illustrates how triangular interpolation splits a surface to be interpolated into two triangular planes in accordance with an embodiment of the invention.

FIG. 3 shows an example of triangular interpolation in accordance with an embodiment of the invention.

FIG. 4 shows a flowchart detailing a process for performing triangular interpolation of an LCD overdrive table in accordance with an embodiment of the invention.

FIG. 5 shows an exemplary display system in accordance with an embodiment of the invention.

FIG. 6 illustrates a system employed to implement the invention.

### DETAILED DESCRIPTION OF SELECTED EMBODIMENTS

Reference will now be made in detail to a particular embodiment of the invention an example of which is illustrated in the accompanying drawings. While the invention will be described in conjunction with the particular embodiment, it will be understood that it is not intended to limit the invention to the described embodiment. To the contrary, it is intended to cover alternatives, modifications, and equivalents as may be included within the spirit and scope of the invention as defined by the appended claims.

Addressing the issues related to interpolation along the main diagonal of an LCD overdrive table, a system, apparatus, and method based on triangular interpolation is described.

In order to improve the performance of LCD panels, the performance of the LCD panel is first characterized by, for example, taking a series of measurements that show what each pixel will do by the end of one frame time. Such measurements are taken for a representative pixel (or pixels) each being initially at a starting pixel value s that is then commanded toward a target value t (where s and t each take on integer values from 0 to 255). If the pixel value actually attained in one frame time is p, then
p=fₛ(t) (1)
where fₛ is the one-frame pixel-response function corresponding to a fixed start-pixel s. For example, the one-frame pixel response function fₛ (t) for a pixel having a start pixel value s=32 and a target pixel value t=192 that can only reach a pixel value p=100 is represented as f₃₂(192)=100.

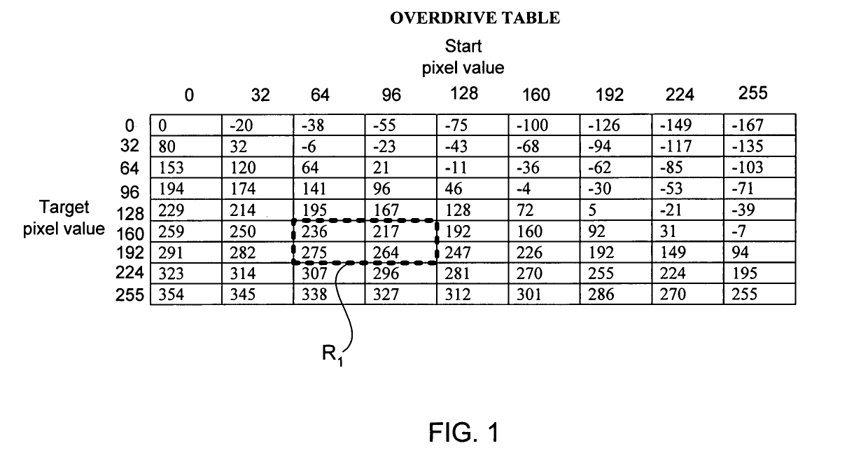

FIG. 1 shows an exemplary overdrive table 100 configured in such a way that a start pixel is given by column j and a target pixel by row i. In order to preserve both computational and memory resources, the table 100 provides only those data points that result from “sub-sampling” of a full overdrive table (not shown) having 256×256 entries, one for each combination of start and target pixel (s,t) in the range of pixel values of 0 to 255. Since the table 100 is based upon a 32-pixel-wide grid (i.e., {0, 32, 64, 96, 128, 160, 192, 224, 255}), there are a number of “missing” rows and columns corresponding to the data points that fall outside of the sampling grid. Therefore, these “missing” values are estimated at runtime based on the inventive interpolation scheme that is used to “read between the lines” of the sparsely populated overdrive table 100.

As described above, it is especially important to eliminate even small errors that occur on the main diagonal where start and target pixels are the same in steady images where pixel shade does not change from frame to frame. If start and target pixels are equal, the overdrive pixel should have the same value as both the start and target pixel values as well. Therefore, in terms of the overdrive function gₛ for the main diagonal is defined in (3) as,
gₛ(s)=s. (2)

In other words, along the main diagonal of the overdrive matrix, the overdrive function gₛ has fixed parameter s that maps each target pixel value t into the overdrive pixel that (if unsaturated) will achieve it. In this way, the overdrive function gₛ can be regarded as a function of two variables, s and t, such that along the main diagonal (i.e., t=s ) the overdrive function g reduces to a function of a single variable equal to the start (and target) pixel s. In other words, the overdrive function g, reduces to the identity function that maps its argument into itself along the main diagonal.

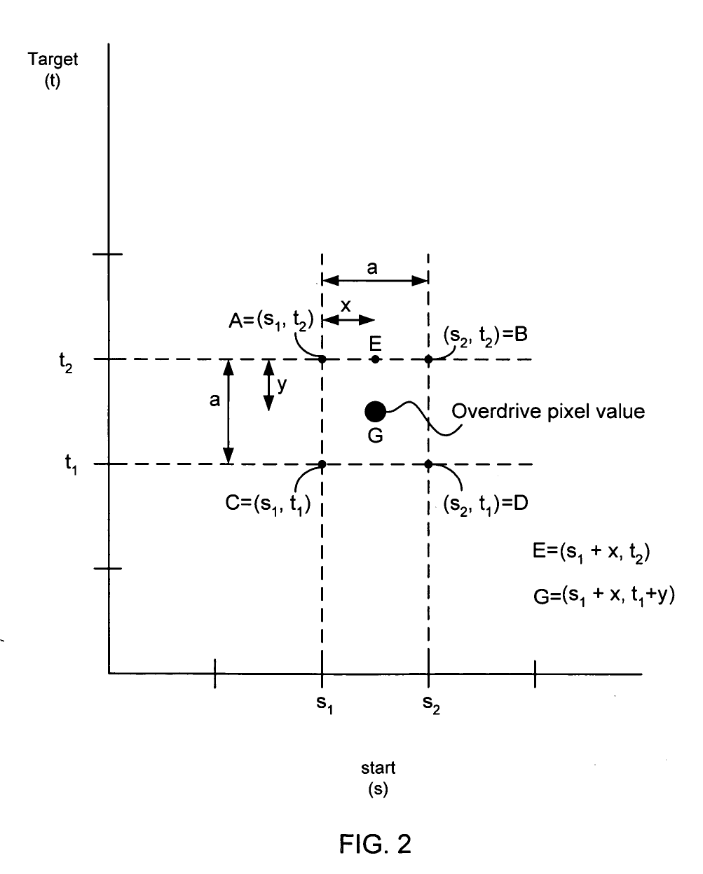

An interpolation method that can be used to determine the intermediate pixel values referred to as triangular interpolation involves splitting the surface into two triangular planes illustrated in FIG. 2. Two triangular planes ABC and ACD model the surface ABCD. Suppose that point G is the objective value. Two steps are required in the process. Firstly, point E is determined by linear interpolation using points A and B. Next, since the slope of EG is equal to the slope of BD, the value at G is obtained by using point E and the slope between BD. Note that by using the slope along BD the denominator in the interpolation is always constant and may be implemented with a shifter instead of a more expensive divider. The equations for calculating the values at E, G are as follows:

$$E = A + ( B - A ) \frac{x}{a} , G = E + ( D - B ) \frac{y}{a} \qquad ( 3 )$$

The set of equations can be simplified to:

$$G = A ( 1 - \frac{x}{a} ) + B ( \frac{x - y}{a} ) + D \frac{y}{a} \qquad ( 4 )$$

G calculated similarly if located in the lower left triangle. Point E is determined by linear interpolation using points A and C. Next, since the slope of EG is equal to the slope of CD, the value at GF is obtained by using point E and the slope between CD. The equations for calculating the values at E, G are as follows:

$$E = A + ( C - A ) \frac{x}{a} , G = E + ( D - C ) \frac{y}{a} \qquad ( 5 )$$

The set of equations can be simplified to:

$$G = A ( 1 - \frac{x}{a} ) + C ( \frac{x - y}{a} ) + D \frac{y}{a} \qquad ( 6 )$$

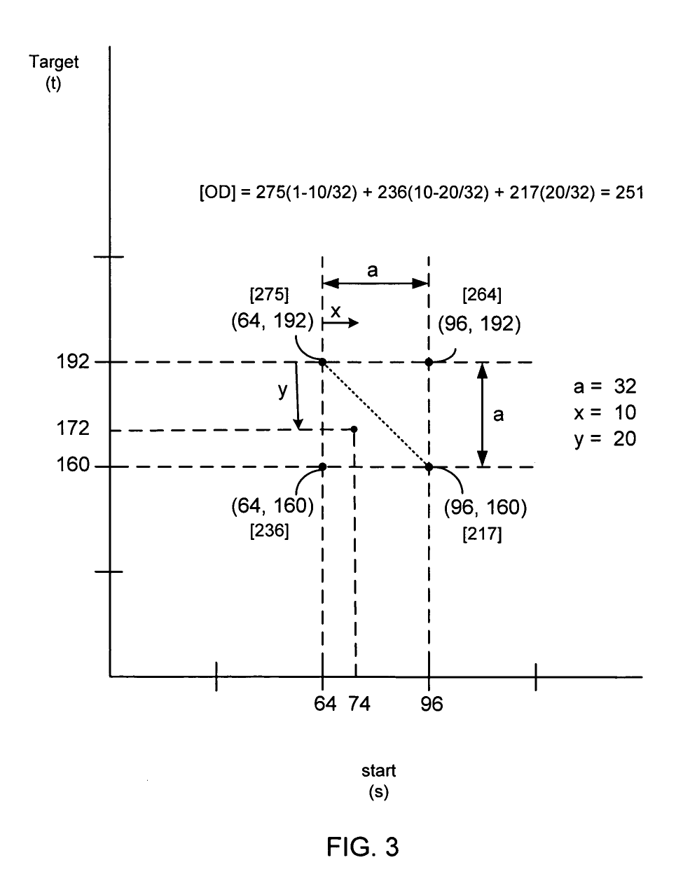

For example, referring to FIG. 3 and the LC overdrive table of FIG. 1, in order to determine an overdrive value g(p) for a start pixel value, target pixel value (s, t)=(74,172), the following analysis is performed. Firstly, the two nearest enumerated neighbors (i.e., (s₁, t₁) and (s₂, t₂)) are determined (which for this case are (s₁, t₁)=(64,160) and (s₂, s₂)=(96,192). Therefore (using the nomenclature of FIG. 2) the corresponding overdrive values for a corresponding rectangle R₁ are
A=275; B=264; C=236; and D=217.

Based upon the values of x (=10) and y (=20), the desired overdrive value g(p) is located in a lower triangle having vertices located at (64,192), (96,160), and (64,160) and therefore, Eq (6) should be used to calculate g(p),
g(p)=275(1-10/32)+236((10-20)/32)+217(20/32)=251.

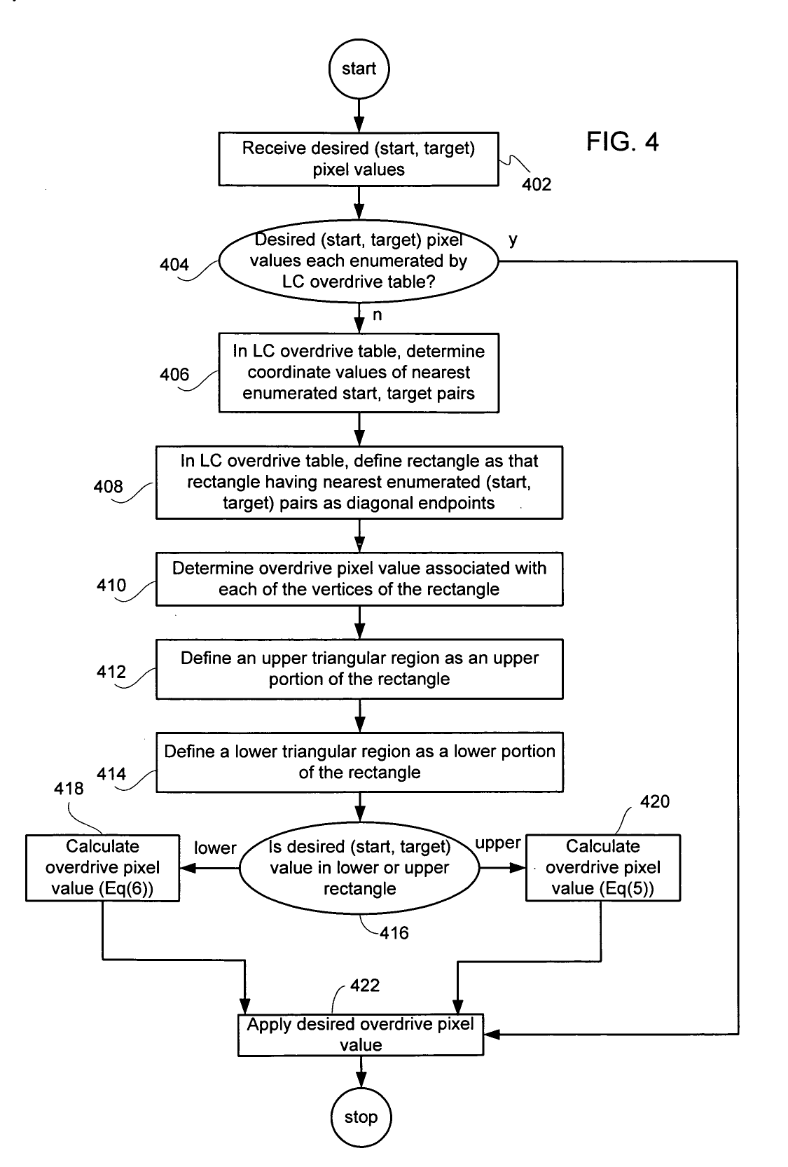

FIG. 4 shows a flowchart detailing a process 400 for calculating a desired overdrive value using a triangular interpolation scheme in accordance with an embodiment of the invention. At 402, the desired start and target pixel values are received while at 404 a determination is made whether or not both the desired start and target pixels are one of the pixel values specifically enumerated by the LC overdrive table. If the determination is no, then a determination of the nearest enumerated pixel values is made at 406 while at 408 a rectangle is defined having the determined nearest enumerated neighbors as diagonal endpoints. At 410, an overdrive pixel value associated with each of the vertices of the defined rectangle is determined while at 412 an upper triangular region of the rectangle is defined and at 414, a lower portion of the rectangle is defined. At 416, a determination is made whether the desired start, target value is located within the upper or the lower triangular region. If the lower triangular region, then at 418 the overdrive pixel value is calculated based upon Eq(6) and if the upper triangular region, then the overdrive pixel value is calculated based upon Eq(5) at 420. In any case, the calculated overdrive pixel value is applied at 422.

Returning back to the determining at 404, if it is determined that the desired start, target pixel values are each specifically enumerated by the LC overdrive table, then the desired overdrive pixel value associated with the enumerated start, target pixel values are applied at 422.

It should be noted that the overdrive method requires a timely and accurate characterization of the LCD panel's optical response. An accurate model allows the overdrive to more accurately predict the response of a given pixel to an applied pixel value thereby allowing a more accurate selection of overdriven value and predicted pixel values. Since LCD panel response is affected by temperature, a long warm up time was used in order to ensure that the optical responses generated through this procedure were consistent. LCD optical response is temperature dependent. This is the case since the viscosity of the liquid crystal material is also dependent on temperature. The liquid crystals must physically rotate and thus its viscosity determines how quickly this rotation can take place. It is the speed of this rotation that determines the response time of a given LCD panel. In general, as the temperature increases, the viscosity of the liquid crystal decreases, thus decreasing the optical response time.

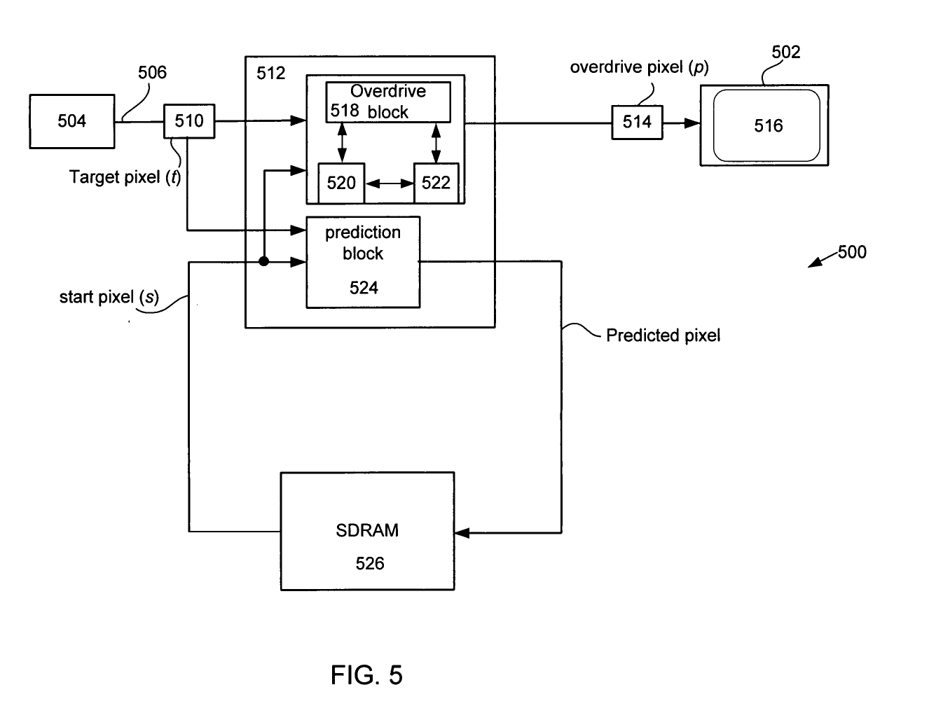

Therefore, FIG. 5 shows a system 500 for displaying a motion enhanced image on an LCD 502 in accordance with an embodiment of the invention. It should be noted, that the system 500 can be used in any number of applications but is most suitable for displaying images prone to exhibiting motion artifacts such as those that include fast motion. The system 500 includes a video source 504 arranged to provide a digital video stream 506 (representative of a number of video frames) formed of a number of data words. As part of a current video frame, an uncompressed target pixel 510 is input to an LCD overdrive unit 512 configured to provide an uncompressed overdrive pixel 514 to the LCD 502 for eventual display on a display screen 516.

In the described embodiment, the overdrive unit 512 includes an overdrive block 518 coupled to an overdrive table 520 (which in this case is implemented as a ROM look up table, or LUT). In those cases where the overdrive table 520 is a sub-sampled type overdrive table, an interpolator unit 522 that “reads between the lines” of the overdrive table 520 provides the requisite overdrive pixel value (p) associated with the overdrive pixel 514 when one or the other of the values of a start pixel value (s) associated with a previous video frame and a target pixel value (t) associated with the current video frame are not one of the enumerated overdrive table pixel values.

A prediction block 524 is used to generate a predicted pixel value (pv) that calculates the actual brightness of the overdriven video frame 514 based upon the overdriven pixel value (p) that is displayed by the LCD 502. In this way, any errors in the observed brightness level that can become a problem when a given target value (t) is not obtainable in one frame can be eliminated. Since the prediction block 524 effectively predicts the amount of any overshoot that occurs in the overdrive pixel value (p), the starting value of the subsequent video frame start value (s) can be adjusted accordingly. In this way, any overshoot can then be corrected in the subsequent video frame.

However, in order to provide the basis for adjusting the subsequent start pixel value, the predicted pixel value (pv) must be provided concurrently with the arrival of the current pixel value (i.e., the next video frame). This delay can be accomplished by storing the predicted pixel value (pv) in a memory unit 526 that typically takes the form of a SDRAM type memory unit. Once the predicted pixel data is stored in the memory unit 528, it is then made available as the previous pixel data that corresponds to the start pixel value (s) for the current video frame. In this way, the overdrive unit 508 can successfully provide the most accurate overdrive pixel value (p).

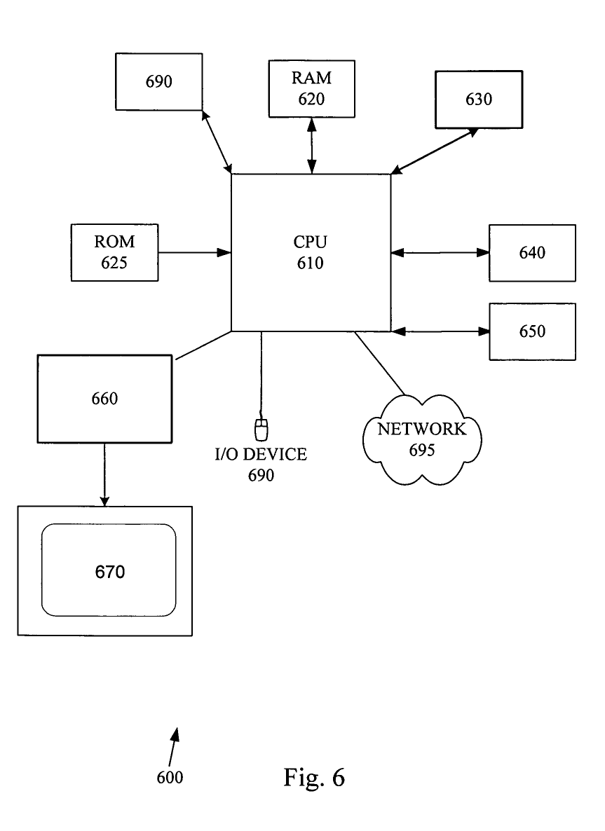

FIG. 6 illustrates a graphics system 600 in which the inventive circuit 500 can be employed. System 600 includes central processing unit (CPU) 610, random access memory (RAM) 620, read only memory (ROM) 625, one or more peripherals 630, primary storage devices 640 and 650, graphics controller 660, and digital display unit 670. CPUs 610 are also coupled to one or more input/output devices 690 that may include, but are not limited to, devices such as, track balls, mice, keyboards, microphones, touch-sensitive displays, transducer card readers, magnetic or paper tape readers, tablets, styluses, voice or handwriting recognizers, or other well-known input devices such as, of course, other computers. Graphics controller 660 generates image data and a corresponding reference signal, and provides both to digital display unit 670. The image data can be generated, for example, based on pixel data received from CPU 610 or from an external encode (not shown). In one embodiment, the image data is provided in RGB format and the reference signal includes the V_{SYNC} and H_{SYNC} signals well known in the art. However, it should be understood that the present invention can be implemented with image, data and/or reference signals in other formats. For example, image data can include video signal data also with a corresponding time reference signal.

Although only a few embodiments of the present invention have been described, it should be understood that the present invention may be embodied in many other specific forms without departing from the spirit or the scope of the present invention. The present examples are to be considered as illustrative and not restrictive, and the invention is not to be limited to the details given herein, but may be modified within the scope of the appended claims along with their full scope of equivalents.

While this invention has been described in terms of a preferred embodiment, there are alterations, permutations, and equivalents that fall within the scope of this invention. It should also be noted that there are many alternative ways of implementing both the process and apparatus of the present invention. It is therefore intended that the invention be interpreted as including all such alterations, permutations, and equivalents as fall within the true spirit and scope of the present invention.

1. In a liquid crystal display device having a number of pixels, a method for reducing a pixel response time required for a selected pixel at a starting pixel value to reach a target pixel value, comprising:
providing a subsampled n×n LCD overdrive table that associates each of set of n² pixel overdrive values to a set of n start pixel values and a corresponding set of n target pixel values;
receiving a desired start and a target pixel value for the selected pixel;
when both of the desired start and the target pixel values are not enumerated by the overdrive table, then generating an overdrive pixel value corresponding to the desired pixel values using triangular interpolation; and
applying the overdrive pixel value to the selected pixel in order to reduce the pixel response time such that the target pixel value is reached within a single frame time.

2. A method as recited in claim 1, wherein when the start pixel value and the target pixel value are equal or almost equal in value, then setting the overdrive pixel value to a main diagonal pixel value such that the start pixel value is equal to the target pixel value.

3. A method as recited in claim 1, wherein the generating an overdrive pixel value using triangular interpolation comprises:
defining a rectangular region based upon coordinates of a first, a second, a third, and a fourth nearest neighbor enumerated start and target pixel values corresponding to the desired start and target pixel values, wherein the rectangular region is formed of an upper triangular region and a lower triangular region wherein the upper triangular region is defined by the first, the second and the third nearest neighbors and wherein the lower triangular region is defined by the first, third and fourth nearest neighbors.

4. A method as recited in claim 3, further comprising:
determining if the desired pixel value is located in the upper triangular region or the lower triangular region.

5. A method as recited in claim 4, wherein when the desired pixel value is located in the upper triangular region, then the overdrive pixel value is generated by interpolating the first, second and third nearest neighbors.

6. A method as recited in claim 4, wherein when the desired pixel value is located in the lower triangular region, then the overdrive pixel value is generated by interpolating the first, fourth and third nearest neighbors.

7. Computer program product for reducing a pixel response time required for a selected pixel at a starting pixel value to reach a target pixel value in a liquid crystal display device having a number of pixels, comprising:
computer code for providing a subsampled n×n LCD overdrive table that associates each of set of n² pixel overdrive values to a set of n start pixel values and a corresponding set of n target pixel values;
computer code for receiving a desired start and a target pixel value for the selected pixel;
computer code for generating an overdrive pixel value corresponding to the desired pixel values using triangular interpolation when both of the desired start and the target pixel values are not enumerated by the overdrive table;
computer code for applying the overdrive pixel value to the selected pixel in order to reduce the pixel response time such that the target pixel value is reached within a single frame time; and
computer readable medium for storing the computer code.

8. Computer program product as recited in claim 7, wherein when the start pixel value and the target pixel value are equal or almost equal in value, then setting the overdrive pixel value to a main diagonal pixel value such that the start pixel value is equal to the target pixel value.

9. Computer program product as recited in claim 7, wherein the computer code for generating an overdrive pixel value using triangular interpolation comprises:
computer code for defining a rectangular region based upon coordinates of a first, a second, a third, and a fourth nearest neighbor enumerated start and target pixel values corresponding to the desired start and target pixel values, wherein the rectangular region is formed of an upper triangular region and a lower triangular region wherein the upper triangular region is defined by the first, the second and the third nearest neighbors and wherein the lower triangular region is defined by the first, third and fourth nearest neighbors.

10. Computer program product as recited in claim 9, further comprising:
computer code for determining if the desired pixel value is located in the upper triangular region or the lower triangular region.

11. Computer program product as recited in claim 10, wherein when the desired pixel value is located in the upper triangular region, then the overdrive pixel value is generated by interpolating the first, second and third nearest neighbors.

12. Computer program product as recited in claim 10, wherein when the desired pixel value is located in the lower triangular region, then the overdrive pixel value is generated by interpolating the first, fourth and third nearest neighbors.

13. An apparatus for reducing a pixel response time required for a selected pixel at a starting pixel value to reach a target pixel value, comprising:
a receiving unit arranged to receive a desired start and a target pixel value for the selected pixel; and
an overdrive block coupled to the receiving unit arranged to generate an overdrive pixel value corresponding to the desired pixel values using triangular interpolation when both of the desired start and the target pixel values are not enumerated by the overdrive table and apply the overdrive pixel value to the selected pixel in order to reduce the pixel response time such that the target pixel value is reached within a single frame time.

14. An apparatus as recited in claim 13, wherein the apparatus is incorporated into a display controller unit suitable for controlling an LCD type display coupled thereto.

15. An apparatus as recited in claim 13, wherein the selected pixel is one of a number of associated pixels that taken together form a pixel stream corresponding to a video for display on the LCD type display.

16. An apparatus as recited in claim 15, wherein selected ones of the pixel stream are stored in a memory unit coupled to the overdrive block.
